(19) United States
(12) Patent Application Publication
(10) Pub. No.: US 2002/0010594 A1
(43) Pub. Date: Jan. 24, 2002

(54) Method of payment for a healthcare service

(76) Inventor: Michael R. Levine, Boca Raton, FL (US)

Correspondence Address: Gifford, Krass, Groh, 280 N. Old Woodward Ave., Suite 400, Birmingham, MI, 48009, US

(21) Appl. No.: 09/812,639

(22) Filed: Mar. 20, 2001

Related U.S. Application Data
(60) Provisional application No. 60/190,688, filed on Mar. 20, 2000.

(51) Int. Cl. G06F 17/60

(52) U.S. Cl. 705/2; 705/39

(57) ABSTRACT

A method of payment for a healthcare service includes the steps of an intermediary issuing a healthcare credit card to a healthcare user, wherein the healthcare user agrees to repay the intermediary for charges incurred by the healthcare user utilizing the healthcare credit card. The method also includes the steps of the intermediary contracting with a healthcare provider, wherein the healthcare provider agrees to perform a predetermined healthcare service and charge the healthcare user a predetermined fee, and the intermediary agrees to pay the healthcare provider the predetermined fee charged the healthcare user. The method further includes the steps of the healthcare user using the healthcare credit card to charge the predetermined fee for receiving the predetermined healthcare service, wherein the intermediary pays the healthcare provider the predetermined fee and the healthcare user reimburses the intermediary.

### REFERENCE TO RELATED APPLICATION

This application claims priority of U.S. provisional patent application Serial No. 60/190,688, filed Mar. 20, 2000, the entire the entire contents of which is incorporated herein by reference.

### FIELD OF THE INVENTION

This invention relates generally to a healthcare payment system, and more specifically, to a method of payment for a healthcare service.

### BACKGROUND OF THE INVENTION

A major concern within the healthcare industry is cost. Healthcare providers, such as hospitals and doctors, want to be paid a reasonable fee in a timely manner for the services they render. At the same time, the cost of these services keeps rising due to many factors both within and outside the control of the healthcare industry, including uninsured patients and the cost of malpractice insurance.

Typically, a healthcare provider performs a healthcare-related service for a patient, and the healthcare provider bills the patient's insurance company for the service. The insurance company is responsible for paying at least a portion of the healthcare costs incurred by a subscriber. The time period between performing the service and receipt of payment may be significant. Patients without insurance or seeking the services of a nonparticipating healthcare provider have to pay the healthcare provider directly, requiring the healthcare provider to collect any amount owed.

Insurance companies have implemented various systems to maintain healthcare costs and pay for services quicker, including establishing health maintenance organizations (HMO), and preferred provider organizations (PPO). The PPO and HMO contracts with a participating doctor to provide a predetermined service at a predetermined cost. While this system works well, the patient may be constrained in the choice of doctor or hospital. Similarly, the U.S. government sponsored healthcare program, Medicare, frequently establishes a fee for a predetermined service that is significantly less than the non-Medicare rate. As a result, the availability of doctors and hospitals accepting Medicare patients is more limited.

Thus, there is a need in the art for a credit card based payment system for healthcare services that allows a patient to immediately pay for the service at the time the service is rendered using a healthcare credit card, and the patient is billed by, and provides payment to, an intermediary, while the healthcare provider is compensated by the intermediary in a timely manner.

### SUMMARY OF THE INVENTION

Accordingly, the present invention provides a method of payment for a healthcare service. The method includes the steps of an intermediary issuing a healthcare instrument such as a credit or debit card to a healthcare user, and wherein the healthcare user agrees to repay the intermediary for charges incurred in utilizing the instrument. As an alternative to carrying a physical medium, reference may be made to a subscriber's account, over the internet, for example, utilizing appropriate identification for credit or debit purposes. The method also includes the steps of the intermediary contracting with a healthcare provider, wherein the healthcare provider agrees to perform a predetermined healthcare service and charge the healthcare user a predetermined fee, and the intermediary agrees to pay the healthcare provider the predetermined fee charged the healthcare user. The method further includes the steps of the healthcare user using the healthcare instrument to pay the healthcare provider the predetermined fee for receiving the predetermined healthcare service, wherein the intermediary pays the healthcare provider the predetermined fee and the healthcare user reimburses the intermediary.

One advantage of the present invention is the use of the instrument in the form of a credit card in the preferred embodiment for prompt payment to a healthcare provider for a healthcare service rendered. Another advantage is the use of an intermediary to contract with a healthcare provider to provide a specific healthcare service for a fixed fee at a competitive rate. Still another advantage of the present invention is that a list of participating healthcare providers is maintained on a website that is accessible to a healthcare user via the Internet. A still further advantage is that the method enables the healthcare user to utilize the instrument for non-healthcare service related purchases.

Other advantages, features and advantages of the present invention will be readily appreciated as the same becomes better understood after reading the subsequent description when taken in conjunction with the accompanying drawings.

### BRIEF DESCRIPTION OF THE DRAWINGS

FIG. 1 is a block diagram of a system for carrying out a method, according to the present invention, of payment for a healthcare service.

FIG. 2 is a flowchart of a method of payment for a healthcare service, according to the present invention.

### DETAILED DESCRIPTION OF THE INVENTION

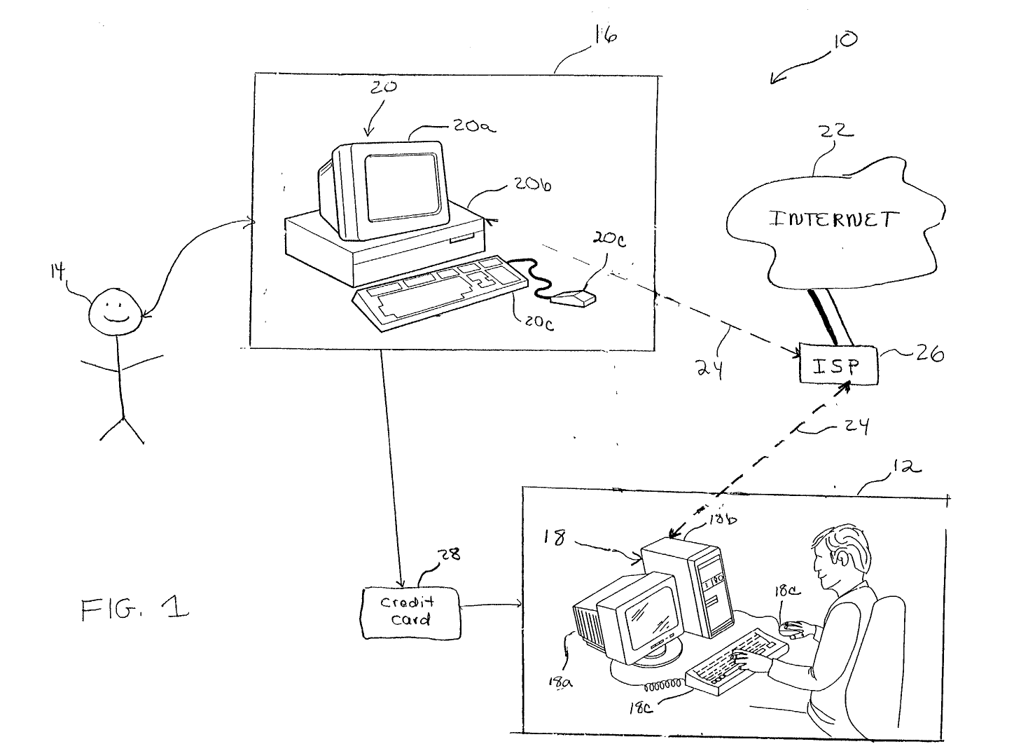

Referring to FIG. 1, a system 10 for carrying out a method of payment for a healthcare service according to the present invention is illustrated. The system 10 involves a healthcare user 12, healthcare provider 14, and an intermediary 16. The healthcare user 12 is an individual receiving a healthcare service. The healthcare provider 14 is a doctor or hospital, or the like, that renders the healthcare service. The intermediary 16 is an entity that contracts with the healthcare user 12 and the healthcare provider 14, to provide the healthcare provider 14 prompt payment at a competitive rate for the healthcare service provided to a contracting healthcare user 12 using a healthcare credit card 28, in a manner to be described. Preferably, the intermediary 16 ensures the healthcare user 12 a fair, competitive price for the service provided by the healthcare provider 14.

The healthcare user 12 has a computer which preferably includes a video monitor 18a, a processor 18b, an input device 18c such as a keyboard or a mouse, and a modem (not shown). The intermediary 16 also has a computer, as shown at 20, including a video monitor 20a, a processor 20b, an input device 20c and a modem (not shown). The computers 18, 20 are connected to an internet infrastructure, such as the Internet 22 via a telecommunications link 24, such as a telephone line or a cable line. As is known in the art, the Internet 22 includes providers 26, such as Internet Access Providers (IAPs), Internet Service Providers (ISPs) and Network Service Providers (NSPs) and routers (not shown) that provide wired and wireless digital telecommunications throughout the world using a TCP/IP networking protocol.

The Internet 22 includes a plurality of website servers (not shown) that interactively transfer information between the healthcare user 12 and intermediary 16 through their computers 18, 20. The website server is a computer system operatively connected to a provider 26 in a conventional manner. When the healthcare user 12 visits the intermediary's website, the healthcare user 12 is served a page displayed on the display monitor 18a. The first page is frequently referred to as a home page. The healthcare user 12 interacts with the page via the input device 18c, such as by making selections or requests.

The intermediary 20 maintains a list of participating healthcare providers 14 at its website. Preferably, each healthcare user 12 is associated with a password, that is presented by the healthcare user 12 to access predetermined information, such as the list of participating healthcare providers 14. An example of a password is a personal identification number (PIN) as is known in the art. Preferably, the website also provides for users 12 to contact the intermediary 16, such as via an e-mail message.

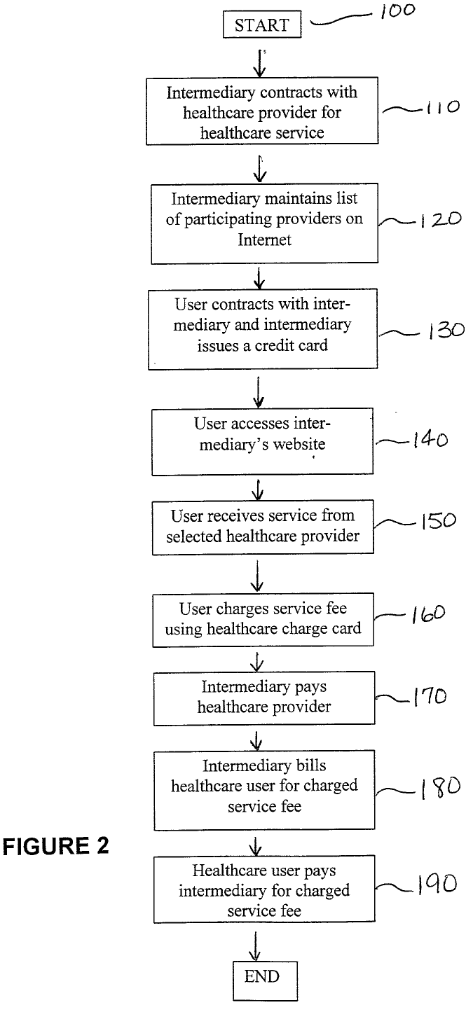

A method, according to the present invention is depicted in FIG. 2. An example of a healthcare service is a routine physical, or a surgical procedure or the like. The healthcare service is performed by the healthcare provider 14. The method begins in bubble 100 and advances to block 110. In block 110, the intermediary 16 contracts with the healthcare provider 14 to provide a participating healthcare user 12 a predetermined healthcare related service for a predetermined fixed fee.

Preferably, the specified contract rate for the predetermined service is generally lower than the rate obtainable by the healthcare user 12 on their own in a free market. For example, the rate may be established at some premium to the rate established by the U.S. government for Medicare payments to healthcare providers, such as 125% of the Medicare rate. Typically, Medicare payment rates are substantially below the rates the healthcare provider 14 would charge an unaffiliated user.

Advantageously, payment to the healthcare provider 14 at the contracted rate is clearly better than the Medicare rate for the same service. Additionally, the healthcare provider 14 receives payment at essentially the time the service is provided, rather than delaying payment by billing an insurance company and subsequently receiving payment from the insurance company, as is typical. From the standpoint of the healthcare user 12, they are assured that the rate charged is reasonable, and substantially less than obtainable by individually contracting with the healthcare provider 14.

The methodology advances to block 120 and the intermediary 16 maintains a list a participating healthcare providers 14, and provides the healthcare user 12 access to the list. For example, the intermediary 16 makes the list of participating healthcare providers 14 available on its Internet website, in a manner previously described. The methodology advances to block 130.

In block 130, the healthcare user 12 contracts with the intermediary 16, similar to a retail credit card agreement as is known in the art, and the intermediary 16 issues a healthcare credit card 28 to the healthcare user 12. Preferably, the contract between the healthcare user 12 and intermediary 16 details that the intermediary 16 will arrange with a predetermined healthcare provider 14 to provide a predetermined healthcare service at a predetermined fee; the intermediary 16 will provide the healthcare user 12 an instrument such as a debit or credit card 28 to pay for the healthcare service; and the intermediary 16 will pay the healthcare provider 14 and the healthcare user 12 will reimburse the intermediary 16.

In the preferred embodiment, the intermediary 16 will establish a credit card account with the healthcare user 12 and issue a healthcare credit card 28 to the healthcare user 12. The healthcare user 12 receives a periodic statement, such as monthly, detailing the services and charges generated during the time period, which the healthcare user 12 is obligated to pay according to conventional terms. It should be appreciated that the contract between the intermediary 16 and the healthcare providers 14 may include a discount, such as 1-5%, to provide a margin of profit for the intermediary 16, similar to a conventional retail credit card operation. Advantageously, the healthcare credit card 28 is available for other purchases, similar to a conventional retail credit card, thus enabling the intermediary to enjoy the financial benefits of a large base of credit card holders.

The methodology advances to block 140. In block 140, the healthcare user 12 accesses the intermediary's website using their computer 18, to select a participating healthcare provider 14. Preferably, the healthcare user 12 is also able to communicate with the intermediary 16 via e-mail, or contract with the intermediary 16 through the intermediary's website.

The methodology advances to block 150, and the healthcare user 12 receives a service from the selected healthcare provider 14. The methodology advances to block 160. In block 160, the healthcare user 12 utilizes the healthcare credit card 28 to pay the service fee charged by the healthcare provider 14. The methodology advances to block 170.

In block 170, the intermediary 16 pays the healthcare provider 14. It should be appreciated that the healthcare provider 14 receives payment for the service in a timely manner, since the fee is prearranged. The healthcare provider 14 thus avoids the delays in payment usually associated with billing an insurance company and waiting for payment from the insurance company. The methodology advances to block 180.

In block 180, the intermediary 16 bills the healthcare user 12 for the service provided by the healthcare provider 14. Preferably, the healthcare user 12 is billed on a periodic basis, such as monthly. The methodology advances to block 190, and the healthcare user 12 pays the intermediary 16 according to the terms agreed upon in the contract between the healthcare user 12 and the intermediary 16 for the charges on the healthcare credit card 28. The methodology advances to bubble 200 and ends.

The present invention has been described in a illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced other than as specifically described.

I claim:

1. A method of payment for a healthcare service, said method comprising the steps of:
issuing, by an intermediary, a healthcare credit card, debit card or other account mechanism to a healthcare user, wherein the healthcare user agrees to repay the intermediary for charges incurred by the healthcare user;
contracting by an intermediary with a healthcare provider, wherein the healthcare provider agrees to perform a predetermined healthcare service and charge the healthcare user a predetermined fee and the intermediary agrees to pay the healthcare provider the predetermined fee charged the healthcare user; and
using the card or other mechanism by the healthcare user to tender the predetermined fee for receiving the predetermined healthcare service, wherein the intermediary pays the healthcare provider the predetermined fee and the healthcare user reimburses the intermediary.

2. A method as set forth in claim 1 including the steps of:
providing the healthcare user access to a website hosted by the intermediary on a computer network;
identifying the healthcare user accessing the healthcare website;
providing the identified healthcare user access to a web page containing healthcare providers contracting with the intermediary; and
selecting by the healthcare user a healthcare provider from the contracting healthcare providers.

3. A method as set forth in claim 2 wherein the computer network is the Internet.

4. A method as set forth in claim 1 including the step of billing the healthcare user by the intermediary for the healthcare service performed by the healthcare service provider.

5. A method of payment for a healthcare service, said method comprising the steps of:
contracting between a healthcare provider and an intermediary for the healthcare provider to perform a predetermined healthcare service for a healthcare user and receive a predetermined fee;
contracting between a healthcare user and the intermediary for the healthcare user to pay the healthcare provider when the healthcare service is performed with a healthcare credit card issued by the intermediary;
receiving by the healthcare user the predetermined healthcare service from the healthcare provider;
charging the fee for the healthcare service using the healthcare credit card;
paying the healthcare provider by the intermediary according to the contract between the healthcare provider and the intermediary for the healthcare service charged to the healthcare credit card; and
paying the intermediary by the healthcare user according to the contract between the healthcare user.

6. A method as set forth in claim 5 including the steps of:
providing the healthcare user access to a website hosted by the intermediary on a computer network;
identifying the healthcare user accessing the healthcare website;
providing the identified healthcare user access to a web page containing healthcare providers contracting with the intermediary; and
selecting by the healthcare user a healthcare provider from the contracting healthcare providers.

7. A method as set forth in claim 6 wherein the computer network is the Internet.

8. A method as set forth in claim 5 including the step of billing the healthcare user by the intermediary for the healthcare service performed by the healthcare service provider, after said step of paying the healthcare provider.

9. A method of payment for a healthcare service, said method comprising the steps of:
contracting between a healthcare provider and an intermediary for the healthcare provider to perform a predetermined healthcare service for a healthcare user and receive a predetermined fee;
contracting between a healthcare user and the intermediary for the healthcare user to pay the healthcare provider when the healthcare service is performed with a healthcare credit card issued by the intermediary;
providing the healthcare user access to a web site hosted by the intermediary on a computer network;
identifying the healthcare user accessing the healthcare website;
providing the identified healthcare user access to a web page containing healthcare providers contracting with the intermediary;
selecting by the healthcare user a healthcare provider from the contracting healthcare providers;
receiving by the healthcare user the predetermined healthcare service from the selected healthcare provider;
charging the fee for receiving the predetermined healthcare service using the healthcare credit card;
paying the selected healthcare provider by the intermediary according to the contract between the healthcare provider and the intermediary for the healthcare service charged to the healthcare credit card; and
paying the intermediary by the healthcare user according to the contract between the healthcare user and the intermediary as payment for the healthcare service rendered by the selected healthcare provider.

10. A method as set forth in claim 9 wherein the computer network is the Internet.

11. A method as set forth in claim 9 including the step of billing the healthcare user by the intermediary for the healthcare service performed by the healthcare service provider, after said step of paying the healthcare provider.
